(19) United States
(12) Patent Application Publication
(10) Pub. No.: US 2009/0322880 A1
(43) Pub. Date: Dec. 31, 2009

(54) CAR WITH MOVEABLE CAMERA UNIT

(75) Inventors: HOU-YAO LIN, Tu-Cheng (TW); SHENG-JUNG YU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/431,777

(22) Filed: Apr. 29, 2009

(30) Foreign Application Priority Data
Jun. 26, 2008 (CN) 200810302365.4

(51) Int. Cl. H04N 7/18

(52) U.S. Cl. 348/148; 348/E07.085

(57) ABSTRACT

A car includes a car body, a camera unit, a driving unit, a display unit, a processing unit and a power source unit. The car body includes a rear portion. The camera unit is moveably coupled to the rear portion and is configured to capture images. The driving unit is to drive the camera unit to move along the rear portion. The display unit is configured to display the captured images. The processing unit is configured to receive the captured images, send the captured images to the display unit to display and control the driving unit to drive the camera unit. The power source unit is configured to supply electrical power to the camera unit, the driving unit, the processing unit and the display unit.

### BACKGROUND

1. Technical Field

The present disclosure relates to cars and particularly, to a car with a moveable camera unit.

2. Description of Related Art

For safety consideration, a typical car is equipped with a camera at a rear portion thereof allowing the driver to view the rear of the car through a display when the car is in reverse mode. However, such the camera is usually a fixed non-moveable and non-rotatable camera, which limits the view angle and range of the rear view captured by the camera. This may cause some inconvenient to the driver not being able to get a good view of the rear of the car.

Therefore, what is needed is to provide a car with a moveable camera unit to overcome the above shortcomings.

### BRIEF DESCRIPTION OF THE DRAWINGS

FIG. 1 is a partially schematic view of a car including a driving unit and a camera unit, according to an exemplary embodiment.

FIG. 2 is a partially schematic view of the driving unit and the camera unit of the car of FIG. 1.

FIG. 3 is a partially schematic view of a car according to another exemplary embodiment.

FIG. 4 is a partially schematic view of a car including a driving unit and a camera unit, according to a further exemplary embodiment.

FIG. 5 is a partially schematic view of the driving unit and the camera unit of the car of FIG. 4.

### DETAILED DESCRIPTION

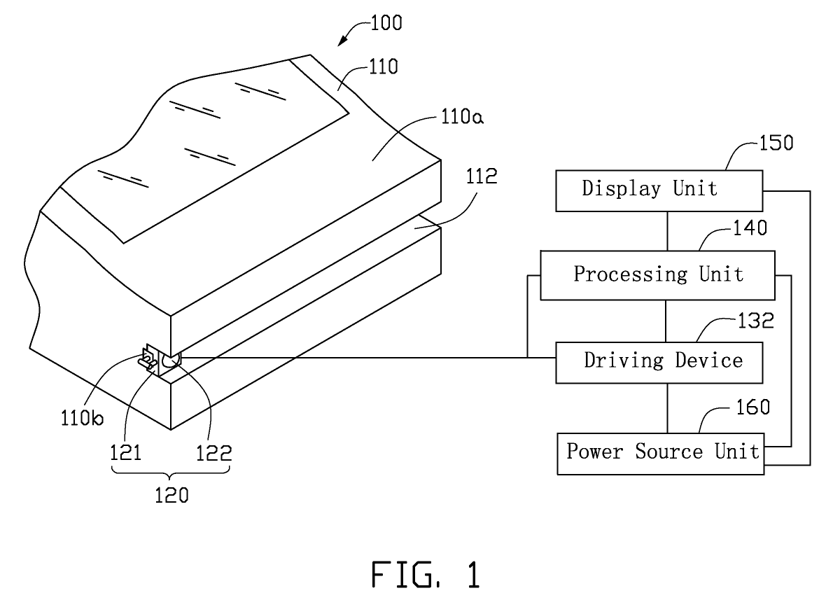

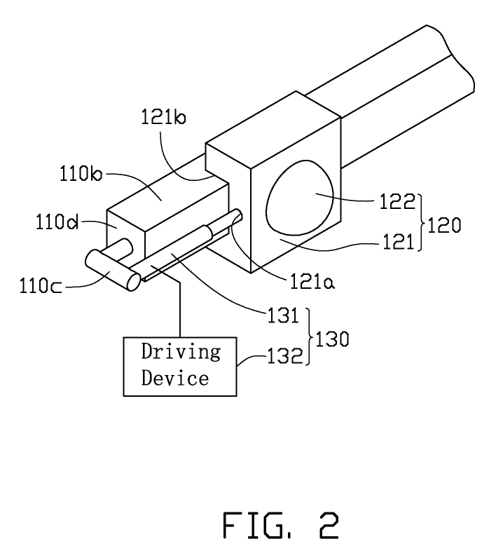

Referring to FIGS. 1 and 2, a car 100, according to an exemplary embodiment, includes a car body 110, a camera unit 120, a driving unit 130, a processing unit 140, a display unit 150 and a power source unit 160. The processing unit 140 is electrically connected to the driving unit 130, the camera unit 120 and the display unit 150. The power source unit 160 is used to supply electrical power to the processing unit 140, the driving unit 130, the camera unit 120 and the display unit 150.

The car body 110 includes a rear portion 110a and an elongated guiding rod 110b. An elongated guiding groove 112 is defined in the rear portion 110a and the elongated guiding rod 110b is received in the elongated guiding groove 112. The elongated guiding rod 110b includes a supporter 110c fixed on an end surface 110d of the elongated guiding rod 110b.

The camera unit 120 includes a base 121 and a camera 122 mounted on the base 121. The camera unit 120 is configured to capture images of the rear view of the car body 110. A receiving hole 121a and a connecting groove 121b are spacedly defined in the base 121 along the elongated guiding rod 110b, and the camera unit 120 is slidably coupled to the elongated guiding rod 110b through the connecting groove 121b. The camera 122 may be a water-proof and wide-angle camera 122. To improve a slide of the camera unit 120, a lubricant layer (not shown) may be coated between the base 121 and the elongated guiding rod 110b.

The driving unit 130 includes a telescopic driving rod 131 and a driving device 132. The driving rod 131 is supported by the supporter 110c and is partially extended in the receiving hole 121a so that the driving rod 131 is fixedly coupled to the base 121. The driving rod 131 is a telescopic rod including numerous parts that slide within one another. The driving device 132 is fixed inside the car body 110. The driving device 132 is configured to drive the driving rod 131 to move back and forth.

The processing unit 140 is configured to control the driving unit 130 to move the camera unit 120 along the elongated guiding rod 110b and to receive images captured by the camera 122 and sends the captured images to the display unit 150 to display. The display unit 150 may include a liquid crystal display arranged inside the car 100. The processing unit 140 may control the driving unit 130 to drive the camera 122 to move so that the camera 122 can capture the surrounding images at various angles in response to user commands through some functional keys (not shown) in the car 100. Therefore, the moveable camera unit 120 is mounted on the rear portion 110a to provide a rear surrounding view of the car 100 at various angles to the driver through the display 150.

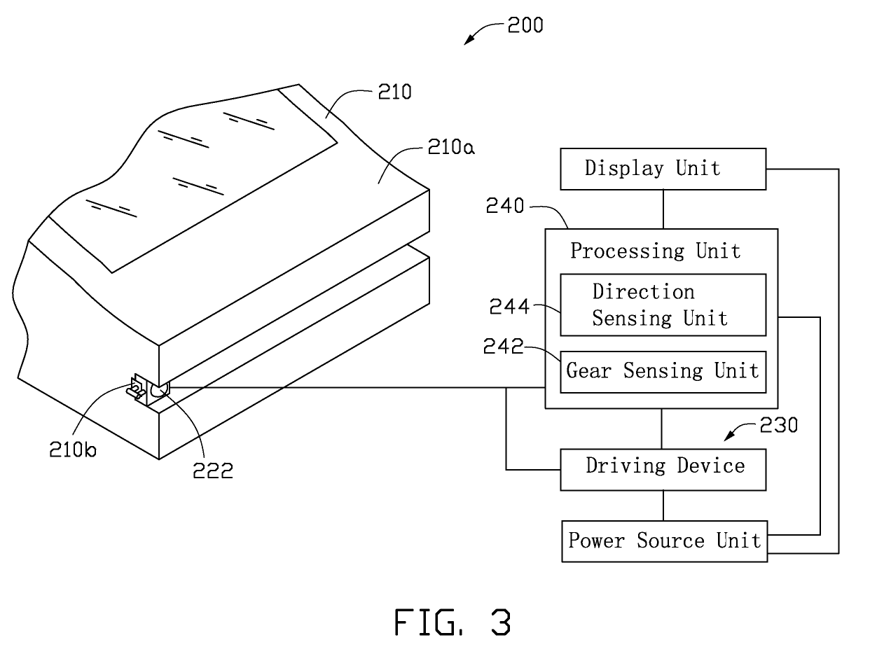

Referring to FIG. 3, a car 200, according to another exemplary embodiment, is shown. Difference between the car 200 of this embodiment and the car 100 is that the processing unit 240 further includes a gear sensing unit 242 and a direction sensing unit 244.

The gear sensing unit 242 is configured to sense a driver's operation of reverse-gear of the car 200, and the processing unit 240 turns on the camera 222 according to the driver's operation of reverse-gear. The direction sensing unit 244 is configured to sense a turning direction of the car 200 when backing. The turning direction may be obtained by sensing a turning direction of a steering wheel (not shown) of the car 200. The processing unit 240 is configured to control the driving unit 230 to move the camera 222 along the elongated guiding rod 210b according to the turning direction of the car 200.

For example, if the driver wants to back the car 200 at a right-hand direction, the reverse gear is activated by the driver and the steering wheel is manipulated by the driver to a right-hand direction. The processing unit 240 turns on the camera 222 and controls the driving unit 230 to move the camera 222 towards a right-hand direction of the rear portion 210a of the body 210 along the elongated guiding rod 210b. In this way, no additional manual activation of the camera 222 is needed when backing the car 200.

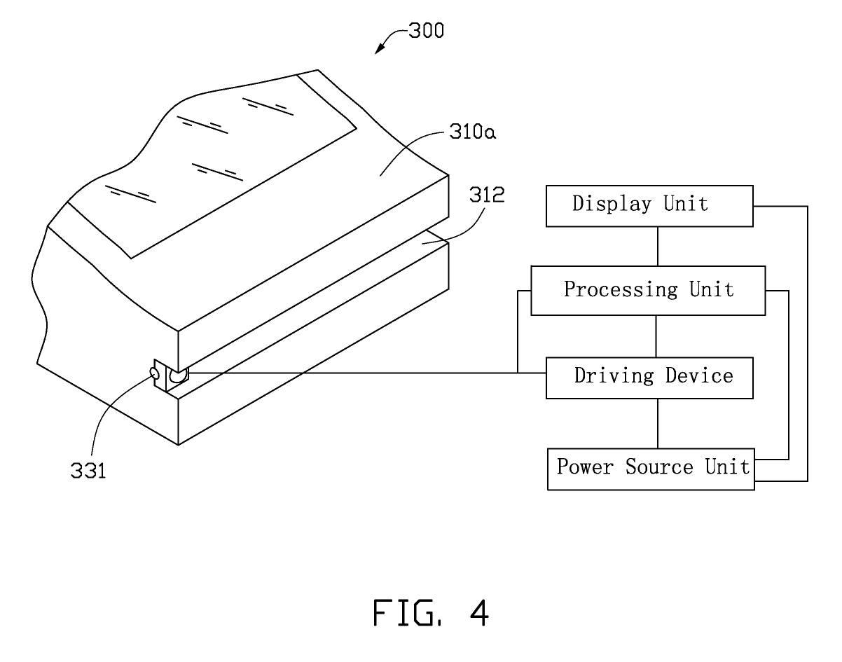

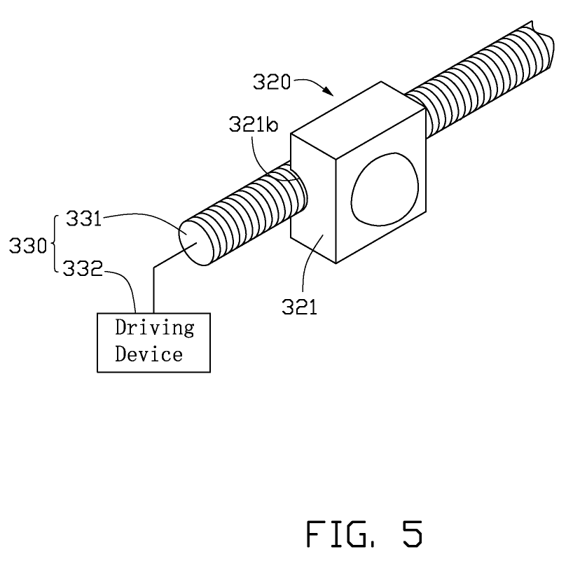

Referring to FIGS. 4 and 5, a car 300, according to a further exemplary embodiment, is shown. Differences between the car 300 of this embodiment and the car 100 are that the driving unit 330 and the base 321, and the elongated guiding rod and the supporter are omitted.

In this embodiment, the driving unit 330 includes an elongated threaded rod 331 and a driving device 332. The elongated threaded rod 331 is rotatably received in the elongated guiding groove 312. The driving device 332 is configured to drive the elongated threaded rod 331 to rotate. A threaded groove 321b is defined in the base 321 instead of the connecting groove. The base 321 is coupled to the elongated threaded rod 331 through the threaded groove 321b so that the camera unit 320 can move along the elongated threaded rod 331 with rotation of the elongated threaded rod 331. Therefore, a moveable camera unit 320 at the rear portion 310a of the car 300 can be achieved.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A car, comprising:
a car body comprising a rear portion;
a camera unit moveably coupled to the rear portion, the camera unit configured to capture images;
a driving unit configured to drive the camera unit to move along the rear portion;
a display unit configured to display the captured images;
a processing unit configured to receive the captured images, send the captured images to the display unit to display and control the driving unit to drive the camera unit; and
a power source unit configured to supply electrical power to the camera unit, the driving unit, the processing unit and the display unit.

2. The car of claim 1, wherein the car body further comprises an elongated guiding rod, the camera unit slidably coupled to the elongated guiding rod and being moveable along the elongated guiding rod.

3. The car of claim 2, wherein an elongated guiding groove is defined in the rear portion, the elongated guiding rod received in the elongated guiding groove.

4. The car of claim 2, wherein the camera unit comprises a base and a camera mounted on the base, a connecting groove defined in the base and aligned with the elongated guiding rod, the camera unit slidably coupled to the elongated guiding rod through the connecting groove.

5. The car of claim 4, wherein the camera is a water-proof and wide-angle camera.

6. The car of claim 2, wherein the elongated guiding rod comprises a supporter fixed on an end surface thereof, and wherein the driving unit comprises a driving device and a telescopic driving rod, the driving rod supported by the supporter and fixedly coupled to the camera unit, the driving device configured to drive the extendable driving rod to move the camera unit along the elongated guiding rod.

7. The car of claim 1, wherein the processing unit comprises a gear sensing unit and a direction sensing unit, the gear sensing unit configured to sense a driver's operation of reverse-gear of the car, the direction sensing unit configured to sense a turning direction of the car, the processing unit configured to turn on the camera unit according to the driver's operation of the reverse-gear and to control the driving unit to move the camera unit along the rear portion according to the turning direction of the car.

8. The car of claim 1, wherein an elongated guiding groove is defined in the rear portion, and wherein the driving unit comprises a driving device and an elongated threaded rod, the elongated threaded rod rotatably received in the elongated guiding groove, the camera unit moveably coupled to the threaded rod, the driving device configured to drive the threaded rod to rotate, thereby moving the camera unit along the threaded rod.

9. The car of claim 8, wherein the camera unit comprises a base and a camera mounted on the base, a threaded groove defined in the base, the base coupled to the elongated threaded rod through the threaded groove.
